(19) United States
(12) Patent Application Publication
(10) Pub. No.: US 2009/0311496 A1
(43) Pub. Date: Dec. 17, 2009

(54) Intermediate Coating Compositions and Methods of Using the Same

(75) Inventors: Mark Edward Nichols, Saline, MI (US); Kevin Richard John Ellwood, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/420,298

(22) Filed: Apr. 8, 2009

Related U.S. Application Data
(60) Provisional application No. 61/073,181, filed on Jun. 17, 2008.

(51) Int. Cl. B32B 27/40; B32B 7/00; B05D 1/36

(52) U.S. Cl. 428/213; 428/425.9; 427/404

(57) ABSTRACT

According to at least one aspect of the present invention, a coating composition is provided. In at least one embodiment, the coating composition includes an intermediate layer having a surface smoothness value, a basecoat layer in overlaying contact with the intermediate layer and including one or more metallic flakes having a size scale, wherein the surface smoothness value of the intermediate layer accommodates the size scale of the one or more metallic flakes of the basecoat layer such that the one or more metallic flakes are substantially aligned to each other to provide the basecoat layer with a liquid metal travel index.

### CROSS-REFERENCE TO RELATED APPLICATIONS

This application claims the benefit of U.S. provisional application Ser. No. 61/073,181 filed Jun. 17, 2008.

### BACKGROUND

1. Technical Field

One aspect of the present invention relates to intermediate coating compositions and another aspect of the present invention relates to applying intermediate coating compositions as part of a paint application system.

2. Background

Many known paint application systems include the application and curing of multiple layers of coatings, which result in the original finish to the exterior surfaces of consumer products and other objects, including, but not limited to, automotive vehicles.

For example, known paint application systems are tailored to impart a liquid metal appearance as the original finish. Liquid metal finishes are desirable due to their highly polished look and relative differences in lightness depending on the angle of viewing the finish.

One proposed metallic paint system includes the manual application of a coating composition followed by several steps of manual sanding of the coating composition to obtain a coating surface layer with the requisite smoothness for application of the metallic paint. This process is very costly due to its labor intensive nature.

### SUMMARY

According to at least one aspect of the present invention, a coating composition is provided. In at least one embodiment, the coating composition includes an intermediate layer having a surface smoothness value, and a basecoat layer in overlaying contact with the intermediate layer and including one or more metallic flakes having a size scale, wherein the surface smoothness value of the intermediate layer accommodates the size scale of the one or more metallic flakes of the basecoat layer such that the one or more metallic flakes are substantially aligned to each other to provide the basecoat layer with a liquid metal travel index.

In at least another embodiment, the surface smoothness value is a distance between two or more surface bumpy features of no greater than 0.1 millimeters.

In at least yet another embodiment, the basecoat layer has a liquid metal travel index in a range of 90 to 140, the liquid metal travel index being defined as a difference between the L15 lightness value and the L110 lightness value. The L15 lightness value is measured at 15 degrees (15′) from a specular reflection of light shined at 45′ to a surface of the basecoat layer and the L110 lightness is measured at 110 degrees (110′) from the specular reflection. In at least one particular embodiment, the basecoat layer has a liquid metal travel index in a range of 100 to 120.

In at least yet another embodiment, the intermediate layer is substantially free of color pigments and metallic flakes.

According to at least another aspect of the present invention, a vehicle part is provided as having thereupon a coating composition described herein. The vehicle part illustratively includes a vehicle door, a vehicle pumper, a vehicle body frame, or any combination thereof.

According to at least yet another aspect of the present invention, a method is provided for coating with improved metallic liquid appearance. In at least one embodiment, the method includes providing a surface having a primer layer thereupon, depositing an intermediate layer material onto the primer layer to form an intermediate layer having a surface smoothness value, and applying a basecoat layer material onto the intermediate layer to form a basecoat layer including one or more metallic flakes having a size scale, wherein the surface smoothness value of the intermediate layer accommodates the size scale of the one or more metallic flakes of the basecoat layer such that the one or more metallic flakes are substantially aligned to each other to provide the basecoat layer with a liquid metal travel index.

In at least another embodiment, the method further includes, after the step of applying, depositing a clearcoat layer onto the basecoat layer.

In at least yet another embodiment, the step of depositing the intermediate layer and the step of applying the basecoat layer are carried out in the same coating booth.

### DETAILED DESCRIPTION OF EMBODIMENTS OF THE PRESENT INVENTION

As required, detailed embodiments of the present invention are disclosed herein. However, it is to be understood that the disclosed embodiments are merely exemplary of the invention that may be embodied in various and alternative forms. Therefore, specific details disclosed herein are not to be interpreted as limiting, but merely as a representative basis for the claims and/or as a representative basis for teaching one skilled in the art to variously employ aspects of the present invention. Moreover, except where otherwise expressly indicated, all numeral quantities in this description indicating amounts of material are to be understood as modified by the word “about” in describing the broadest scope of the invention. Practice within the numerical limit stated is generally preferred.

Unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with at least one aspect of the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; and the first definition of an acronym or other abbreviation applies to all subsequent uses herein of the same abbreviation and applies mutatis mutandis to normal grammatical variations of the initially defined abbreviation.

It has been found, according to one or more embodiments of the present invention, that metallic flakes in a basecoat layer should be aligned to each other in order to achieve a satisfactory face brightness and liquid metal appearance. Liquid metal finishes are desirable due to their highly polished look and sharp difference in lightness depending on the angle of viewing. Surface roughness negatively impacts the liquid metal appearance by forcing the metal flakes to lie less than parallel to the surface of the basecoat layer. Roughness exposes the edges of the metallic flakes to the human eye, such that individual flakes can be resolved. In addition, misalignment of the flakes decreases the head on brightness of the metallic basecoat layer. It is thus recognized, according to one or more embodiments of the present invention, that improving the smoothness of an underlying surface onto which the metallic basecoat layer is to be applied is beneficial to achieving an acceptable liquid metal appearance.

Creating smooth coatings is desirable in many aspects of automotive coating applications. Application conditions can be modified and coating formulations can be adjusted to achieve acceptable surface smoothness for various coating systems. However, surface roughness is itself an end product of many competing variables that need to be concurrently considered. From a coating application standpoint, viscosity, sag resistance, line speed, curing conditions, and film build are all needed to be factored in. From a materials perspective, other properties such as chip resistance, durability, etch resistance need also be considered. As such, since coating layers including one or more electrocoat layers, primer layers and basecoat layers all have intended functions respectively assigned to, design windows for surface smoothness are often narrowed in order to accommodate the more pressed needs related to each of the intended functions. In many scenarios, neither application conditions nor material properties can be optimized to maximize surface smoothness.

For example, a primer layer has been conventionally used as an underlayer upon which a metallic basecoat layer is directly applied. Since the primer layer is mainly to further the rust control concurrently delivered by an electrocoat layer that is usually applied underneath the primer layer, the primer layer contains many protective solid species and thus often has a relatively thicker consistency and or an altered configuration when applied. As a result, an effort to enhance the smoothness may very well be at the cost of compromising the intended functions of the primer layer. That is at least one reason the art has been using manual or mechanical sanding to prepare a primed surface for metal paint applications. Simply, the art has been confronted with this long felt but yet unmet need to prepare a surface, and particularly a surface that has been traditionally pre-treated with an electrocoat layer and a primer layer, to have a surface smoothness optimized for the subsequent metal liquid paint application.

It has also been found, according to one or more embodiments of the present invention, that the liquid metal effect of a metallic basecoat layer can be substantially enhanced through the employment of at least one intermediate layer to facilitate metal flake alignment by providing a suitable level of surface smoothness to stage the metallic basecoat layer. As such, the surface smoothness value of the intermediate layer accommodates the size scale of the metallic flakes in the metallic basecoat layer such that the metallic flakes are substantially aligned relative to each other to provide a liquid metal travel index that is improved over conventional systems. One such conventional system is a metallic basecoat layer applied over a surface or a paint layer this pre-treated with manual or mechanical sanding.

As used herein, by the phrase “the surface smoothness value of the intermediate layer accommodates the size scale of the metallic flakes, it is meant that the bumpiness or roughness of the intermediate layer surface is so minimized that substantially all of the metallic flakes in the basecoat layer align to each other and or lay substantially “flat” relative to a planar surface of the basecoat layer.

One or more embodiments of the present invention relate to metallic paint coating compositions for imparting a liquid metal appearance as an original surface finish. An improved liquid metal appearance is achieved by providing an intermediate layer with a relatively high level of smoothness. A metallic paint having metallic flakes is applied and cured onto the intermediate layer. Due to the smoothness of the intermediate layer, the applied metallic paint cures so that the metallic flakes are substantially aligned in the plane of the metallic paint coating, thereby providing an acceptable liquid metal appearance. Such alignment is desired to achieve relatively high face brightness and relatively high travel of the cured metallic paint, which are the main attributes for imparting an acceptable liquid metal appearance as the original finish.

As one example, certain paint application systems include the application of a metallic paint as the last layer of the paint application system. The metallic paint includes metallic flakes, such as aluminum flakes, mica flakes, aluminum flakes, bronze flakes, nickel flakes, silver flakes, copper flakes, and the like. The metallic paint is used to impart a liquid metal look to the finished coating. The liquid metal look is achieved, according to one or more embodiments of the present invention, by providing relatively high face brightness and relatively high travel in the cured metallic paint. Such characteristics are achieved by providing a relatively high level of the alignment of the metallic flakes in the cured metallic paint.

The surface smoothness of the intermediate layer for receiving the metallic paint affects the level of alignment of the metallic flakes. Surface roughness may cause the metallic flakes to lie less than parallel to the surface of the cured metallic coating, thereby negatively impacting the liquid metal appearance of the finished product.

One or more embodiments of the present invention recognize the relative importance of various application conditions and material properties relating to an intermediate layer as described herein. Surface smoothness can hardly be optimized merely through modifying application conditions or adjusting paint formulations, since the extent of surface smoothness may be largely limited due to competing application variables, such as viscosity, sag resistance, line speed, curing conditions, and film build. Further, from a materials perspective, other properties, such as chip resistance, durability, and etch resistance, are also typically considered. Therefore, in many scenarios, neither application variables nor material properties can be optimized to maximize smoothness.

One or more embodiments of the present invention recognize that smoothness is the one particular property that may be optimized above all others with respect to coating systems for imparting an acceptable liquid metal appearance. The requisite smoothness is achieved by applying a relatively thin layer of intermediate layer in preparation for applying the metallic basecoat layer. The intermediate layer can be tailored to smooth the coating surface for subsequent application of the metallic basecoat layers. The intermediate layer may obtain its smooth surface attribute without mechanical processing.

According to at least one aspect of the present invention, a coating composition is provided for application onto a surface. In at least one embodiment, the coating composition includes an intermediate layer having a surface smoothness value, and a basecoat layer in overlaying contact with the intermediate layer and including one or more metallic flakes having a size scale, wherein the surface smoothness value of the intermediate layer accommodates the size scale of the one or more metallic flakes of the basecoat layer such that the one or more metallic flakes are substantially aligned to each other to provide the basecoat layer with a liquid metal travel index.

As used herein and unless otherwise noted, the term “layer” or “layers” refers to general coating regions or areas which can be applied by one or more spray passes but do not necessarily mean that there is a distinct or abrupt interface between adjacent layers, i.e., there can be some migration of components between the layers.

The surface can be a surface of any suitable substrates. Examples of suitable substrates include wood; glass; leather; plastics; metals, such as iron, steel, zinc, aluminum, titanium, and alloys thereof with one another or with other metals; minerals such as cement, clay, ceramic, natural stone, artificial stone; foams; fiber materials, such as glass fibers, ceramic fibers, carbon fibers, textile fibers, polymer fibers, metal fibers, or composite fibers; or substrates that have already been coated or primed, such as automobiles or automobile parts.

In certain particular embodiments, the surface is provided with an electrocoat layer, a primer coat, or combinations thereof. In the event that both the electrocoat layer and the primer layer are provided, the electrocoat layer and the primer layer are in overlaying contact with each other.

As used herein and unless otherwise noted, the surface smoothness value of the intermediate layer can be determined based on the bumpy features on the surface. The bumpy features may have a height of no greater than 0.1 millimeters, and in some particular instances no greater than 0.03 millimeters, and be spaced apart from each other by a similar distance.

In one or more embodiments of the present invention, a roughness scale of below 0.03 millimeters is achieved. The surface is smoothed based on the size scale of he metallic paint flakes, such as a size scale of less than or equal 0.025 millimeters for aluminum flakes. Achieving smoothness at a size scale below 0.03 millimeters with an intermediate layer represents a departure from conventional systems in which the paint system is optimized to be smoothed in the 0.1 to 0.3 millimeter range or the 0.3 to 1.0 millimeter range.

Commercial instruments, such as the BYK WAVESCAN available from BYK-Garner GmbH of Coretsried, Germany, are utilized to characterize roughness of a painted surface, and categorize the roughness within one of a number of different size scale categories. One exemplary size categorization includes the following five (5) categories: (1) 0.03 to 0.1 millimeters; (2) 0.1 to 0.3 millimeters; (3) 0.3 to 1.0 millimeters; (4) 1.0 to 3.0 millimeters; and (5) 3.0 to 10.0 millimeters.

In at least one particular embodiment, the coating composition further includes a clearcoat layer in overlaying contact with the basecoat layer and directed away from the intermediate layer. In this configuration, the basecoat layer is disposed between the clearcoat layer and the intermediate layer.

In at least another particular embodiment, the intermediate layer is formed from a material having a viscosity relatively low to provide relatively good flowability and leveling. In at least yet another particular embodiment, the viscosity of the material to form the intermediate layer is lower than a viscosity of a material to form the basecoat layer, and optionally lower than the viscosity of a material to form a clear coat. In at least yet another particular embodiment, the viscosity of the material to form the intermediate layer is in the range of 20 to 200 centipoises.

As used herein and unless otherwise noted, the term “viscosity” is commonly defined and in particular refers to a measure of the resistance of a liquid which is being deformed by either shear stress or extensional stress. In general terms it is the resistance of a liquid to flow, or its “thickness”.

In at least yet another particular embodiment, the intermediate layer is in chemical composition similar, if not identical, to a clearcoat layer.

In at least yet another particular embodiment, the basecoat layer is present with a liquid metal travel index in a range of 90 to 140. The angles are measured relative to the specular reflection. Light is shined at 45 degrees (45′) to the surface. The specular reflection is then at minus 45′ or −45′. The L15 lightness is measured at 15′ from the specular angle (−45′) and the L110 lightness is measured at 110′ from the specular angle (−45′) or from back on the other side of the illuminant. The liquid metal travel index is then defined as the difference in L15 lightness value and L110 lightness value. In at least yet another particular embodiment, the basecoat layer is present with a liquid metal travel index in a range of 100 to 120.

In at least yet another particular embodiment, the intermediate layer has a thickness smaller than a thickness of the basecoat layer. In at least yet another particular embodiment, the intermediate layer has a thickness in a range of 0.3 to 1.2 mils, 0.4 to 1.0 mils, or particularly 0.5 to 0.8 mils.

As used herein and unless otherwise noted, the term of “substantially free” indicates that one or more additives are not purposefully, as opposed to incidentally, added into the intermediate layer according to at least one embodiment of the present invention. The additives may include color pigments, effect pigments such as metallic flakes, ultraviolet blockers, dispersing agents, deformers, preservatives, wetting agents, and combinations thereof. In the event that the color pigments and or metallic flakes are accidentally mixed into the intermediate layer, the amounts of the color pigments and or the metallic flakes are no greater than 2.0, 1.5, 1.0, or 0.5 weight percent of total dry solids of the intermediate layer.

The metallic flakes can be of any geometrical shapes including shapes of square, round, oval, triangle, and the like. The metallic flakes can be made of any suitable metals. Non-limiting examples of the metals include silver, copper, iron, platinum, chromium, or combinations thereof.

According to at least another aspect of the present invention, a vehicle part is provided as having thereupon a coating composition described herein. The vehicle part can be any component of a vehicle upon which a coating composition may be applied. Non-limiting examples of the vehicle part include a vehicle door, a vehicle pumper, a vehicle body frame, or any combination thereof.

According to at least yet another aspect of the present invention, a method is provided for coating with improved metallic liquid appearance. In at least one embodiment, the method includes providing a surface having a primer layer thereupon, depositing an intermediate layer material onto the primer layer to form an intermediate layer having a surface smoothness, and applying a basecoat layer material onto the intermediate layer to form a basecoat layer having one or more metallic flakes, wherein the intermediate layer material has a viscosity lower than a viscosity of the basecoat layer, and wherein the surface smoothness of the intermediate layer is in sync with a size scale of the one or more metallic flakes of the basecoat layer such that the one or more metallic flakes are substantially aligned to provide an improved liquid metal appearance of the basecoat layer.

In at least one particular embodiment, the intermediate layer is substantially a clearcoat layer in chemical composition. Prior to adding the basecoat layer, the intermediate layer can be flash dried but not substantially cured. In this scenario, the intermediate layer and the liquid metal basecoat layer can be cured wet-on-wet in typical fashion. The only physical modification necessary in the plant would be the addition of one circulation system to accommodate the intermediate coat in the topcoat spray booth. As such, the subject surface simply goes through the topcoat booth twice to accommodate the addition of the intermediate coat. Many plants are currently equipped for such a process modification. If the volume of liquid metal paint jobs is kept at a reasonably level, negative impact on normal production should be not be significant, if not nominal. However, it is also operable to fully cure the intermediate layer before the subsequent addition of the basecoat layer.

In at least another embodiment, the method further includes, after the step of applying, depositing a clearcoat layer in one or more passes onto the basecoat layer. In at least yet another embodiment, the step of depositing the intermediate layer and the step of applying the basecoat layer are carried out in the same coating booth. In at least yet another embodiment, the step of depositing further includes depositing an intermediate layer having a viscosity lower than a viscosity of the clearcoat layer. In at least yet another embodiment, the step of depositing further includes depositing an intermediate layer substantially free of additives selected from the group consisting of ultraviolet protectors, color pigments, and combinations thereof.

In at least another embodiment, an electrocoat layer is deposited and cured over a vehicle surface body. The electrocoat layer is typically applied at a sufficient thickness to produce a cured coating layer with a thickness of 0.6 to 1.2 mils. A primer layer is then deposited and cured over the cured electrocoat. The primer layer is typically applied at a sufficient thickness to produce a cured coating layer with a thickness of 0.6 to 1.2 mils. An intermediate layer is then applied and cured over the cured primer layer. The intermediate layer is typically applied at a sufficient thickness to produce a cured coating layer with a thickness of 0.3 to 1.2 mils. A basecoat layer is then applied over the cured intermediate layer. In certain embodiments, the layer may also be referred as the topcoat layer. The basecoat layer is typically applied at a sufficient thickness to produce a cured coating layer with a thickness of 0.5 to 2.5 mils, or particularly 0.8 to 1.9 mils. In at least one embodiment, the basecoat layer is a metallic paint including metallic flakes. A clearcoat layer is then applied over the applied, but uncured base coat layer. The clearcoat layer is typically applied at a sufficient thickness to produce a cured coating layer with a thickness of 1.2 to 2.5 mils. In at least one embodiment, the base coat and clearcoat layers are cured at the same time.

In at least yet another embodiment, an electrocoat layer is applied by a dip process in a relatively large tank to obtain a coating layer that is subsequently cured in an oven. After the electrocoat layer curing step is completed, the object being painted, such as a vehicle, enters a spray booth where a primer layer is applied that is subsequently cured in an oven. Then, the primed vehicle body surface is transferred to a second paint booth for application and subsequent curing of the intermediate layer. Then, the vehicle body surface including the cured intermediate layer is re-introduced into the second paint booth to apply the basecoat layer and clearcoat layer, which are cured in a single curing step, using known wet-on-wet application and curing techniques. A recirculation system can be coupled to the second paint booth to accommodate the application of the intermediate layer to the vehicle body surface.

In at least yet another embodiment, a roughness scale of below 0.03 millimeters is achieved with the application of the intermediate layer. The surface is smoothed based on the size scale of the metallic paint flakes, such as a size scale of less than or equal to 0.025 millimeters for aluminum flakes. Achieving smoothness at a size scale below 0.03 millimeters with an intermediate layer represents a departure from conventional systems in which the paint system is optimized to be smoothed in the 0.1 to 0.3 millimeter range or the 0.3 to 1.0 millimeter range.

As surface roughness of the cured substrate layer decreases, the travel of the liquid metal coating system increases. Smoother substrates result in improved liquid metal appearance of the finished coating.

As the metallic paint layer may be applied and cured to impart a liquid metal appearance to the surface, the travel of a metallic paint layer applied and cured may be determined. The travel may be a measure of the difference in brightness between a first direction such as perpendicular to the paint surface, and a second direction, such as a direction nearly parallel to the paint surface.

In certain particular embodiments, the travel is defined as the lightness when viewed at a first angle, e.g., 15′, off of the specular reflection, minus the lightness at a second angle, e.g. 110′, off the specular reflection.

Light is shined at 45 degrees (45′) to the surface. The specular reflection is then at minus 45′ or −45′. The L15 lightness is measured at 15′ from the specular angle (−45′) and the L110 lightness is measured at 110′ from the specular angle (−45′) or from back on the other side of the illuminant. The liquid metal travel index is then defined as the difference in L15 lightness value and L110 lightness value.

In certain other particular embodiments, the first angle is 15′ and the second angle is 110′. In one embodiment, a travel of 130 is targeted for achieving improved liquid metal appearance. In another embodiment, a travel of 140 is targeted for achieving improved liquid natural appearance.

The intermediate layer can be formulated using a number of starting materials. Because its main purpose is to provide a smooth surface for application of the metallic paint layers, UV durability, scratch performance and other properties do not need to be optimized. As such, addition of the intermediate layer does not substantially incur costs otherwise associated with the optimization of these various properties. Non-limiting examples of chemistries that can be utilized for intermediate coating compositions include acrylic/melamine, acrylic/silane/melamine, carbamate, urethane, epoxy-acid and polyester. However, other chemistries can be used as long as the resulting intermediate coating composition includes the physical properties identified above.

Useful crosslinkable resins include acrylic polymers, polyesters, alkyds, polyurethanes, polyamides, polyethers and copolymers and mixtures thereof. These resins can be self-crosslinking or crosslinked by reaction with suitable crosslinking materials included in the coating composition.

Suitable acrylic polymers include copolymers of one or more alkyl esters of acrylic acid or methacrylic acid, optionally together with one or more other polymerizable ethylenically unsaturated monomers. Useful alkyl esters of acrylic acid or methacrylic acid include aliphatic alkyl esters containing from 1 to 30, and preferably 4 to 18 carbon atoms in the alkyl group. Non-limiting examples include methyl methacrylate, ethyl methacrylate, butyl methacrylate, ethyl acrylate, butyl acrylate, and 2-ethyl hexyl acrylate. Suitable other copolymerizable ethylenically unsaturated monomers include vinyl aromatic compounds such as styrene and vinyl toluene; nitrites such as acrylonitrile and methacrylonitrile; vinyl and vinylidene halides such as vinyl chloride and vinylidene fluoride; and vinyl esters such as vinyl acetate.

Alkyd resins or polyester polymers can be prepared in a known manner by condensation of polyhydric alcohols and polycarboxylic acids. Suitable polyhydric alcohols include ethylene glycol, propylene glycol, butylene glycol, 1,6-hexylene glycol, neopentyl glycol, diethylene glycol, glycerol, trimethylol propane and pentaerythritol. Suitable polycarboxylic acids include succinic acid, adipic acid, azelaic acid, sebacic acid, maleic acid, fumaric acid, phthalic acid, tetrahydrophthalic acid, hexahydrophthalic acid and trimellitic acid. Besides the polycarboxylic acids mentioned above, functional equivalents of the acids such as anhydrides where they exist or lower alkyl esters of the acids such as methyl esters can be used. Where it is desired to produce air-drying alkyd resins, suitable drying oil fatty acids can be used and include those derived from linseed oil, soya bean oil, tall oil, dehydrated castor oil, or tung oil. The polyesters and alkyd resins contain a portion of free hydroxyl and/or carboxyl groups which are available for further crosslinking reactions.

Useful polyurethanes include polymeric polyols which are prepared by reacting polyester polyols or acrylic polyols, such as those mentioned above, with a polyisocyanate such that the OH/NCO equivalent ratio is greater than 1:1 so that free hydroxyl groups are present in the product.

For the use of forming a basecoat layer, the crosslinkable resin can be an aqueous dispersion of a blend of acrylic and polyester and/or polyurethane materials in microparticulate form. Such dispersions can be produced by a high stress technique using a homogenizer. In this technique, the polymeric resin is a latex which comprises polymeric microparticles prepared by forming a mixture in aqueous medium of an ethylenically unsaturated monomer or mixture of ethylenically unsaturated monomers with a substantially hydrophobic polymer. The hydrophobic polymer is essentially free of repeating acrylic or vinyl units in the polymer backbone and has a molecular weight of greater than about 300 grams per mole. The hydrophobic polymer is preferably a polyester or polyurethane. The monomer(s) and hydrophobic polymer are particularized into microparticles by high stress techniques using a homogenizer followed by polymerizing the ethylenically unsaturated monomer(s) to form polymeric microparticles which are stably dispersed in the aqueous medium. These microparticles can be internally crosslinked so as to form microgels.

Generally, the crosslinkable resin is present in an amount ranging from about 25 to about 100 weight percent on a basis of total resin solids of a coating composition, preferably about 40 to about 95 weight percent and, more preferably, greater than 70 weight percent to about 90 weight percent. When the coating composition of the present invention is to be used as a clearcoat with an acrylic resin, it is preferred that the acrylic resin be present in an amount greater than 70 weight percent to about 95 weight percent on a basis of total resin solids of the coating composition.

The coating composition can further comprise one or more crosslinking materials capable of reacting with the crosslinkable resin to form a crosslinked film.

Suitable crosslinking materials include aminoplasts, polyisocyanates, polyacids, anhydrides and mixtures thereof. Useful aminoplast resins are based on the addition products of formaldehyde with an amino- or amido-group carrying substance. Condensation products obtained from the reaction of alcohols and formaldehyde with melamine, urea or benzoguanamine are most common and preferred herein. While the aldehyde employed is most often formaldehyde, other similar condensation products can be made from other aldehydes, such as acetaldehyde, crotonaldehyde, acrolein, benzaldehyde, furfural, glyoxal and the like.

### EXAMPLE

A liquid metal basecoat layer is painted over a variety of sample surfaces having various levels of surface smoothness. Sample surface #1 is a primed surface that has been once sanded for intended smoothness. Sample surface #2 is a primed surface that has been twice sanded for intended smoothness. Sample surface #3 is a primed surface that has been painted with a clear coat as a functional equivalent to the intermediate layer according to one or more of the present invention.

The surface smoothness is measured using a profilometer which calculates an average surface roughness value, Ra, in micrometer (μm). The liquid metal appearance is quantified by measuring the travel of the base coat. As defined herein elsewhere, the travel is the difference between the lightness L15 value, as opposed to the lightness L110 value. In certain particular embodiments, the travel is defined as the lightness when viewed at a first angle, e.g., 15′, off of the specular reflection, minus the lightness at a second angle, e.g. 110′, off the specular reflection.

Light is shined at 45 degrees (45′) to the surface. The specular reflection is then at minus 45′ or −45′. The L15 lightness is measured at 15′ from the specular −45′ angle and the L110 lightness is measured at 110′ from the specular −45 angle or from back on the other side of the illuminant. The liquid metal travel index is then defined as the difference in L15 lightness value and L110 lightness value.

Preferably, and as discussed herein elsewhere, for the liquid metal color the travel should be as big as possible. The metallic basecoat layer should look substantially bright head-on and look substantially dark at an oblique angle. Table I illustrates the effect of underlayer's smoothness on the liquid metal travel of the basecoat layer.

TABLE I
effect of surface smoothness on liquid metal
effect

| Sample # | Ra (μm) | Travel |
|---|---|---|
| 1 | 583 | 101.4 |
| 2 | 197 | 104.9 |
| 3 | 120 | 107.1 |

The above identified effect of surface smoothness on liquid metal effect does not in any way limit what the intermediate layer can potentially achieve according to one or more embodiments of the present invention. Rather, the example nicely illustrates that smoothing out an underlayer using a clear coat as the intermediate coat substantially decreases the Ra value upon which the metallic base coat is painted, wherein the liquid metal travel value of the base coat is substantially increased as opposed to samples that have not been treated with a clear coat as the intermediate coat immediately underneath the metallic base coat.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A coating composition comprising:
an intermediate layer having a surface smoothness value; and
a basecoat layer in overlaying contact with the intermediate layer and including one or more metallic flakes having a size scale;
wherein the surface smoothness value of the intermediate layer accommodates the size scale of the one or more metallic flakes in the basecoat layer such that the one or more metallic flakes are substantially aligned to each other to provide the basecoat layer with a liquid metal travel index.

2. The coating composition of claim 1, wherein the surface smoothness value being a distance between two or more surface bumpy features of no greater than 0.1 millimeters.

3. The coating composition of claim 1, wherein the basecoat layer has a liquid metal travel index in a range of 90 to 140, the liquid metal travel index being defined as the difference in lightness viewed at a first angle of 15 degrees (15′) off of a specular reflection of light shined at 45′ to a surface of the basecoat layer minus the lightness at a second angle of 110 degrees (110′) off of the specular reflection.

4. The coating composition of claim 3, wherein the basecoat layer has a liquid metal travel index in a range of 100 to 120.

5. The coating composition of claim 1, wherein the intermediate layer is substantially free of color pigments and metallic flakes.

6. The coating composition of claim 1 further comprising a primer layer in overlaying contact with the intermediate layer such that the intermediate layer is disposed between the primer layer and the basecoat layer.

7. The coating composition of claim 5 further comprising an electrocoat layer such that the primer layer is disposed between the electrocoat layer and the intermediate layer.

8. The coating composition of claim 1 further comprising a clearcoat layer in overlaying contact with the basecoat layer such that the basecoat layer is disposed between the intermediate layer and the clearcoat layer.

9. The coating composition of claim 1, wherein the intermediate layer has a thickness smaller than a thickness of the basecoat layer.

10. The coating composition of claim 1, wherein the intermediate layer is substantially free of additives selected from the group consisting of ultraviolet blockers, pigments, dispersing agents, defoamers, preservatives, wetting agents, and combinations thereof.

11. A vehicle part having thereupon a coating composition of claim 1.

12. A coating composition comprising:
a primer layer;
an intermediate layer in overlaying contact with the primer layer and having a surface smoothness value;
a basecoat layer in overlaying contact with the intermediate layer and including one or more metallic flakes, the intermediate layer being disposed between the primer layer and the basecoat layer;
wherein the surface smoothness value of the intermediate layer accommodates the size scale of the one or more metallic flakes of the basecoat layer such that the one or more metallic flakes are substantially aligned to each other to provide the basecoat layer with a liquid metal travel index.

13. The coating composition of claim 12, wherein the surface smoothness value being a distance between two or more surface bumpy features of no greater than 0.1 millimeters.

14. The coating composition of claim 12, wherein the intermediate layer is substantially free of color pigments and metallic flakes.

15. The coating composition of claim 12, wherein the basecoat layer has a liquid metal travel index in a range of 100 to 120, the liquid metal travel index being defined as the difference in lightness viewed at a first angle of 15 degrees (15′) off of a specular reflection of light shined at 45′ to a surface of the basecoat layer minus the lightness at a second angle of 110 degrees (110′) off of the specular reflection.

16. A method for coating with improved metallic liquid appearance, comprising:
providing a surface having a primer layer thereupon;
depositing an intermediate layer material onto the primer layer to form an intermediate layer having a surface smoothness value;
applying a basecoat layer material onto the intermediate layer to form a basecoat layer including one or more metallic flakes having a size scale;
wherein the surface smoothness value of the intermediate layer accommodates the size scale of the one or more metallic flakes of the basecoat layer such that the one or more metallic flakes are substantially aligned to each other to provide the basecoat layer with a liquid metal travel index.

17. The method of claim 16 further comprising, after the step of applying, depositing a clearcoat layer onto the basecoat layer.

18. The method of claim 16, wherein the step of providing includes providing a surface having an electrocoat layer and a primer layer with the electrocoat layer being disposed between the surface and the primer layer.

19. The method of claim 16, wherein the step of depositing the intermediate layer and the step of applying the basecoat layer are carried out in the same coating booth.

20. The method of claim 17, wherein intermediate layer is substantially free of color pigments.
